(19) United States
(12) Patent Application Publication
(10) Pub. No.: US 2002/0022734 A1
(43) Pub. Date: Feb. 21, 2002

(54) Polyfluoroalkylsilanes

(76) Inventors: Albrecht Marhold, Leverkusen (DE); Jurgen Wiedemann, Leverkusen (DE); Sebastian Bach, Achsheim (DE)

Correspondence Address: BAYER CORPORATION, PATENT DEPARTMENT, 100 BAYER ROAD, PITTSBURGH, PA, 15205, US

(21) Appl. No.: 09/895,774

(22) Filed: Jun. 29, 2001

(30) Foreign Application Priority Data
Jul. 5, 2000 (DE) 10032632.3

(51) Int. Cl. C07F 7/08; C07F 7/10

(52) U.S. Cl. 556/415; 556/414; 556/437; 556/427; 556/428; 556/478

(57) ABSTRACT

The invention relates to the preparation and use of polyfluoro-alkylsilanes of formula (I)

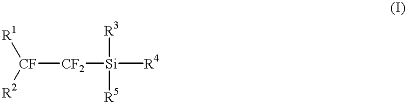

in which

R¹ and R² are independently hydrogen, halogen, straight-chain or branched C₁-C₈-alkyl, C₃-C₉-cycloalkyl, C₁-C₈-alkoxy, C₁-C₈-alkylthio, C₆-C₁₄-aryl, C₁-C₈-alkyl-, acyl-, sulfonyl-, or C₆-C₁₄-aryl-disubstituted amine, C₆-C₁₄-aryloxy, C₆-C₁₄-arylthio, heteroaryl, heteroaryloxy, or cyano, wherein said radicals, apart from hydrogen, halogen, and cyano, can optionally be substituted, and

R³, R⁴ and R⁵ are independently straight-chain or branched C₁-C₈-alkyl or C₆-C₁₄-aryl, which optionally carry one or more substituents selected from the series consisting of halogen, C₁-C₄-alkyl, C₁-C₄-alkoxy, C₆-C₁₄-aryloxy, silyloxy, nitro, cyano, C₁-C₄-alkyl-, acyl-, sulfonyl-, or C₆-C₁₄-aryl-disubstituted amine, disilylamino, and COO(C₁-C₆-alkyl).

### BACKGROUND OF THE INVENTION

The invention relates to polyfluoroalkylsilanes, to a process for their preparation, to their use, and to liquid crystals prepared therewith.

Fluorinated organic molecules are of great importance for the preparation of polymers, agrochemicals, and pharmaceuticals. In particular in the area of pharmaceuticals, a large number of effective antiviral, antitumor, and antifungal substances whose efficacy is based on the introduction of one or more polyfluorinated groups has successfully been developed.

In pharmaceuticals, there is particular interest in perfluoroalkyl compounds, since the presence of perfluoroalkyl groups favors the transport and the absorption rate in the body of a medicament that has been taken. Perfluoroalkyl compounds are furthermore used in the preparation of liquid crystals.

Perfluoroalkylsilyl compounds are capable of transferring perfluoroalkyl groups to other molecules.

It is known to prepare perfluoroalkylsilyl compounds by reaction of perfluoroalkyl bromides or iodides with trimethylchlorosilane. The reaction is carried out in the presence of tris(diethylamido)phosphine (Ruppert et al., Tetrahedron Lett., 25 1984, 2195-2198) or tetrakis(dimethylamino)-ethane (Pawelke, J. Fluorine Chem., 42, 1989, 429-433). This process has the disadvantage that perfluoroalkyl bromides and iodides are not obtainable inexpensively. The high costs of the starting compounds greatly restrict the applicability of the process described above for industrial production.

It is furthermore known to prepare perfluoroalkylsilyl compounds by reaction of perfluoroalkyl bromides and trialkylchlorosilanes in N-methyl pyrrolidone in the presence of aluminum (Grobe et al., Synleft., 1995, 641-642). The high costs of the starting compounds are also disadvantageous in this process.

Long-chain perfluoroalkylsilanes can be prepared by reaction of perfluoroalkyl halides and trimethylchlorosilane by a Grignard reaction (see, for example, Smith et al., J. Organomet. Chem., 46, 1972, 251-254). However, this process has the disadvantage that the method is not suitable for the preparation of short perfluoroalkylsilanes, such as, for example, trimethyltrifluoromethylsilane. It is furthermore disadvantageous that Grignard reactions can usually be controlled only with difficulty and are therefore of only limited suitability for large-scale industrial application.

The object was therefore to provide a process that allows technically simple preparation of perfluoroalkylsilanes starting from inexpensive starting materials.

### SUMMARY OF THE INVENTION

Surprisingly, a process has now been found for the preparation of polyfluoroalkylsilanes of formula (I)

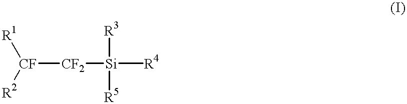

in which

R¹ and R² are identical or different and are hydrogen, halogen, straight-chain or branched C₁-C₈-alkyl, C₃-C₉-cycloalkyl, C₁-C₈-alkoxy, C₁-C₈-alkylthio, C₆-C₁₄-aryl, C₁-C₈-alkyl-, acyl-, sulfonyl-, or C₆-C₁₄-aryl-disubstituted amine, C₆-C₁₄-aryloxy, C₆-C₁₄-arylthio, heteroaryl, heteroaryloxy, or cyano, wherein said radicals, apart from hydrogen, halogen, and cyano, optionally carry one or more substituents selected from the series consisting of halogen, C₁-C₄-alkyl, C₁-C₄-alkoxy, C₆-C₁₄-aryloxy, silyloxy, nitro, cyano, C₁-C₄-alkyl-, acyl-, sulfonyl-, or C₆-C₁₄-aryl-disubstituted amine, disilylamino, and COO(C₁-C₆-alkyl), and

R³, R⁴, and R⁵ are identical or different and are straight-chain or branched C₁-C₈-alkyl or C₆-C₁₄-aryl, which optionally carry one or more substituents selected from the series consisting of halogen, C₁-C₄-alkyl, C₁-C₄-alkoxy, C₆-C₁₄-aryloxy, silyloxy, nitro, cyano, C₁-C₄-alkyl-, acyl-, sulfonyl-, or C₆-C₁₄-aryl-disubstituted amine, disilylamino, and COO(C₁-C₆-alkyl),

comprising reacting compounds of formula (II)

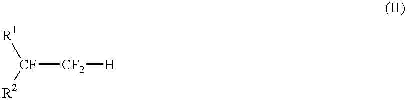

wherein R¹ and R² are as defined above,

with compounds of formula (III)

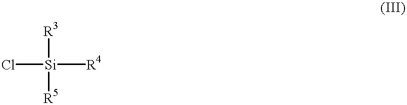

wherein R³, R⁴, and R⁵ are as defined above,

in the presence of a base.

### DETAILED DESCRIPTION OF THE INVENTION

Compounds of formula (II) that are preferably employed in the process according to the invention are those in which R¹ is as defined above and R² is halogen.

Use is particularly preferably made of compounds of formula (II) in which R₁ is halogen, C₁-C₈-alkyl, C₁-C₈-alkoxy, or C₆-C₁₄-aryloxy, and R² is fluorine.

Compounds of formula (III) that are preferably employed in the process according to the invention are those in which R³, R⁴, and R⁵ are identical or different and are straight-chain or branched C₁-C₆-alkyl, which optionally carries one or more substituents selected from the series consisting of halogen, C₁-C₄-alkyl, C₁-C₄-alkoxy, C₆-C₁₄-aryloxy, silyloxy, nitro, cyano, C₁-C₄-alkyl-, acyl-, sulfonyl-, or C₆-C₁₄-aryl-disubstituted amine, disilylamino, and COO(C₁-C₆-alkyl).

Use is particularly preferably made of compounds of formula (III) in which R³, R⁴, and R⁵ are identical and are C₁-C₆-alkyl.

Use is very particularly preferably made in the process according to the invention of compounds of formula (II) in which R¹ is halogen, C₁-C₈-alkyl, C₁-C₈-alkoxy, or C₆-C₁₄-aryloxy, and R² is fluorine, and compounds of formula (III) in which R³, R⁴, and R⁵ are identical and are C₁-C₆-alkyl.

Compounds of formula (III) are preferably employed in the process according to the invention in an amount of from 0.5 to 20 equivalents, in particular from 0.9 to 5 equivalents and very particularly preferably from 1 to 2 equivalents, based on the compounds of formula (II).

Strong bases are preferably employed in the process according to the invention. Preferred strong bases are, for example, strong inorganic bases, such as sodium hydride and potassium hydride. These bases are preferably employed in the presence of a sulfone, such as tetramethyl sulfone. Preferred organic bases are alkoxides of lithium, sodium, and potassium, such as potassium tert-butoxide, alkyllithium, alkylsodium, and alkylpotassium compounds, such as, for example, n-butyllithium, lithium dialkylamides, and potassium dialkylamides, and tris(trialkyl)silylamines. Particularly preferred bases are n-butyllithium, potassium tert-butoxide, and sodium hydride in the presence of tetramethyl sulfone. Such bases may, if necessary, be activated by addition of complexing agents, such as, for example, tetrakis(dialkylamino)ethane.

It is also possible to employ mixtures of different strong bases.

The base is preferably employed in an amount of from 0.5 to 20 equivalents, in particular from 0.9 to 5 equivalents and very particularly preferably from 1 to 2 equivalents, based on the compounds of formula (II).

The process according to the invention can be carried out in the presence or absence of a solvent. If the process according to the invention is carried out in the absence of a solvent, an excess of compounds of formula (III) is advantageous. If the process according to the invention is carried out in the presence of a solvent, aprotic solvents are preferably employed. Preferred solvents are monoethers and polyethers, such as tetrahydrofuran, dialkyl ethers or diglyme, alkanes, such as hexane or cyclohexane, or aromatic compounds, such as toluene or xylene. Particularly preferred solvents are methyl tert-butyl ether and diethyl ether.

The reaction can be carried out, for example, at temperatures of from −100° C. to +200° C., preferably from -20° C. to +20° C., particularly preferably from −5° C. to +10° C.

The reaction is preferably carried out under a protective gas, such as nitrogen, helium, or argon.

The process according to the invention can be carried out by initially introducing the trialkylchlorosilane of formula (III) into a reaction vessel, optionally in the presence of a solvent. The compound of formula (II) is preferably metered in. The base is preferably then metered in. The mixture is preferably stirred, and the progress of the reaction can be monitored by gas-chromatographic analysis. The reaction mixture can be worked up by distillation.

The present invention furthermore relates to compounds of formula (I) in which

R¹ and R² are identical or different and are hydrogen, halogen, straight-chain or branched C₁-C₈-alkyl, C₃-C₉-cycloalkyl, C₁-C₈-alkoxy, C₁-C₈-alkylthio, C₆-C₁₄-aryl, C₁-C₈-alkyl-, acyl-, sulfonyl-, or C₆-C₁₄-aryl-disubstituted amine, C₆-C₁₄-aryloxy, C₆-C₁₄-arylthio, heteroaryl, heteroaryloxy, or cyano, wherein said radicals, apart from hydrogen, halogen, and cyano, optionally carry one or more substituents selected from the series consisting of halogen, C₁-C₄-alkyl, C₁-C₄-alkoxy, C₆-C₁₄-aryloxy, silyloxy, nitro, cyano, C₁-C₄-alkyl-, acyl-, sulfonyl-, or C₆-C₁₄-aryl-disubstituted amine, disilylamino, and COO(C₁-C₆-alkyl), and

R³, R⁴, and R⁵ are identical or different and are straight-chain or branched C₁-C₈-alkyl or C₆-C₁₄-aryl, which optionally carry one or more substituents selected from the series consisting of halogen, C₁-C₄-alkyl, C₁-C₄-alkoxy, C₆-C₁₄-aryloxy, silyloxy, nitro, cyano, C₁-C₄-alkyl-, acyl-, sulfonyl-, or C₆-C₁₄-aryl-disubstituted amine, disilylamino, and COO(C₁-C₆-alkyl),

with the proviso that R¹ is not hydrogen, halogen, or fluoroalkyl if R² is fluorine or chlorine.

Preferred compounds of formula (I) are those in which R¹ is as defined above, R² is halogen, and R³, R⁴, and R⁵ are identical or different and are straight-chain or branched C₁-C₆-alkyl, which optionally carries one or more substituents selected from the series consisting of halogen, C₁-C₄-alkyl, C₁-C₄-alkoxy, C₆-C₁₄-aryloxy, silyloxy, nitro, cyano, C₁-C₄-alkyl-, acyl-, sulfonyl-, or C₆-C₁₄-aryl-disubstituted amine, disilylamino, and COO(C₁-C₆-alkyl).

Particularly preferred compounds of formula (I) are those in which R¹ is halogen, C₁-C₈-alkyl, C₁-C₈-alkoxy or C₆-C₁₄-aryloxy, R² is fluorine, and R³, R⁴, and R⁵ are identical and are C₁-C₆-alkyl.

The polyfluoroalkylsilanes according to the invention and the poly-fluoroalkylsilanes prepared by the process according to the invention can serve as transfer agents for polyfluoroalkyl groups in synthetic chemistry for the preparation of active ingredients in the area of pharmaceuticals or agrochemistry. In addition, the polyfluoroalkylsilanes according to the invention and the polyfluoroalkylsilanes prepared by the process according to the invention can be used for the preparation of high-quality liquid crystals for optical displays. This enables the introduction of novel polyfluoroalkyl groups into potential active ingredients and liquid crystals. In addition, the costs for the preparation of polyfluoroalkylated compounds can be reduced to the low preparation costs of the polyfluoroalkylsilanes according to the invention.

The present invention furthermore relates to liquid crystals of formula (IV)

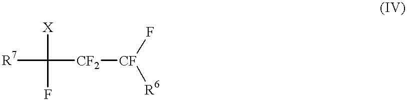

in which

X is fluorine or hydrogen,

R⁶ is hydrogen, fluorine, polyfluoro-C₁-C₈-alkyl, C₁-C₈-alkoxy, C₆-C₁₄-aryloxy, or heteroaryloxy, wherein said radicals, apart from hydrogen and fluorine, optionally carry one or more substituents selected from the series consisting of halogen, C₁-C₄-alkyl, C₁-C₄-alkoxy, C₆-C₁₄-aryloxy, silyloxy, nitro, cyano, C₁-C₄-alkyl-, acyl-, sulfonyl-, or C₆-C₁₄-aryl-disubstituted amine, disilylamino and COO(C₁-C₆-alkyl), and

R⁷ is optionally substituted C₆-C₁₄-aryl or C₆-C₁₈-cycloalkyl.

Preferred liquid crystals of formula (IV) are those in which

X is hydrogen,

R⁶ is hydrogen, fluorine, polyfluoro-C₁-C₄-alkyl, or straight-chain or branched C₁-C₄-alkoxy, which, apart from hydrogen, fluorine, and polyfluoroalkyl, are substituted by one or more fluorine atoms, and

R⁷ is a phenyl radical, a biphenyl radical, or a cyclohexyl radical, which optionally carry one or more substituents selected from the series consisting of straight-chain or branched C₄-C₁₈-alkyl, C₁-C₁₂-alkyl-C₅-C₈-cycloalkyl, and C₅-C₈-cycloalkyl.

Particularly preferred liquid crystals of formula (IV) are those in which

X is hydrogen,

R⁶ is hydrogen, fluorine, trifluoromethyl, or pentafluoroethyl, and

R⁷ is a phenyl radical which carries a substituent selected from the series consisting of C₄-C₁₈-alkyl and C₁-C₁₂-alkyl-C₅-C₈-cycloalkyl in the para-position.

The present invention furthermore relates to a process for the preparation of liquid crystals of formula (IV) comprising

(1) reacting compounds of formula (I)

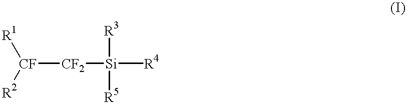

in which

R¹ has the same range of meanings as for R⁶ in formula (IV),

R² is fluorine, and

R³, R⁴, and R⁵ are identical or different and are straight-chain or branched C₁-C₈-alkyl or C₆-C₁₄-aryl, which optionally carry one or more substituents selected from the series consisting of halogen, C₁-C₄-alkyl, C₁-C₄-alkoxy, C₆-C₁₄-aryloxy, silyloxy, nitro, cyano, C₁-C₄-alkyl-, acyl-, sulfonyl-, or C₆-C₁₄-aryl-disubstituted amine, disilylamino, and COO(C₁-C₆-alkyl),

with compounds of formula (V)

R⁷—Y (V)

in which

Y is a group that is reactive toward —SiR³R⁴R⁵ (preferably an aldehyde, keto, or ester group), and

R⁷ is optionally substituted C₆-C₁₄-aryl or C₆-C₁₈-cycloalkyl, in the presence of compounds that have strong affinity to silicon, giving compounds of formula (VI)

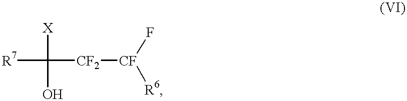

in which

R⁶ has the same range of meanings as R¹ in formula (I), and

R⁷ is as defined for formula (V), and

(2) subsequently reacting these compounds with fluorinating agents.

Compounds that have strong affinity to silicon are, for example, those that function as fluoride or alkoxy donors, for example, fluorides, such as tetrabutylammonium fluoride, or alkoxides, such as sodium methoxide.

Preferred fluorides are alkylammonium fluorides, such as, for example, tetrabutylammonium fluoride, or alkali metal fluorides, such as, for example, sodium fluoride or potassium fluoride. Particular preference is given to tetrabutylammonium fluoride.

Preferred alkoxides are alkali metal alkoxides, such as, for example, sodium methoxide or sodium ethoxide.

Fluorinating agents are compounds that are capable of replacing OH in compounds of formula (VI) by F, such as, for example, diethyl-aminosulfur trifluoride.

Compounds of formula (I) that are preferably employed in the process according to the invention for the preparation of compounds of formula (IV) are those in which

R¹ has the preferred range of meanings as indicated for R⁶ under formula (IV),

R² is fluorine, and

R³, R⁴, and R⁵ are identical or different and are straight-chain or branched C₁-C₆-alkyl or C₆-C₁₄-aryl, which optionally carry one or more substituents from the series consisting of halogen, C₁-C₄-alkyl, C₁-C₄-alkoxy, C₆-C₁₄-aryloxy, silyloxy, nitro, cyano, C₁-C₄-alkyl-, acyl-, sulfonyl-, or C₆-C₁₄-aryl-disubstituted amine, disilylamino, and COO(C₁-C₆-alkyl).

Compounds of formula (I) that are particularly preferably employed in the process according to the invention for the preparation of compounds of formula (IV) are those in which

R¹ is hydrogen, fluorine, trifluoromethyl, or pentafluoroethyl, and

R² is fluorine, and

R³, R⁴, and R⁵ are identical and are C₁-C₆-alkyl.

Compounds of formula (V) that are preferably employed in the process according to the invention for the preparation of compounds of formula (IV) are those in which

R⁷ is a phenyl radical, a biphenyl radical, or a C₆-C₁₈-cyclohexyl radical, which optionally carry substituents selected from the series consisting of straight-chain or branched C₄-C₁₈-alkyl, C₁-C₁₂-alkyl-C₅-C₈-cycloalkyl, and C₅-C₈-cycloalkyl, and

Y is an aldehyde, keto, or ester group.

Use is particularly preferably made of compounds of formula (V) in which

R⁷ is a phenyl radical that carries a substituent selected from the series consisting of C₄-C₁₈-alkyl and C₁-C₁₂-alkyl-C₅-C₈-cycloalkyl in the para-position, and

Y is an aldehyde, keto, or ester group.

In a particularly preferred embodiment of the process according to the invention for the preparation of compounds of formula (IV), compounds of formula (I) in which

R¹ is hydrogen, fluorine, trifluoromethyl, or pentafluoroethyl,

R² is fluorine, and

R³, R⁴, and R⁵ are identical and are C₁-C₆-alkyl, are reacted with compounds of formula (V) in which

R⁷ is a phenyl or biphenyl radical that carries a substituent from the series consisting of C₄-C₁₈-alkyl and C₁-C₁₂-alkyl-C₅-C₈-cyclohexyl in the paragraph-position, and

Y is an aldehyde, keto, or ester group,

in the presence of fluorides or alkoxides, to give compounds of formula (VI)

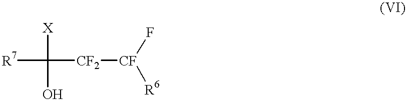

and the latter are reacted with the fluorinating agent diethylaminosulfur trifluoride to give compounds of formula (IV).

In the process according to the invention for the preparation of compounds of formula (IV), preferably from 0.5 to 20 equivalents, in particular from 0.9 to 5 equivalents, very particularly preferably from 1 to 2 equivalents, of compounds of formula (I) are employed, based on the compounds of formula (V).

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

### Example 1

300 ml of methyl tert-butyl ether and 13.6 g (125.1 mmol) of trimethylchlorosilane were introduced under nitrogen into a 1 liter four-necked flask fitted with stirrer, thermometer, and gas inlet capillary, and the mixture was cooled to 0° C. When the target temperature had been reached, 15.75 g (81.2 mmol) of phenoxytetrafluoroethane were added dropwise. 50 ml (125 mmol) of n-butyllithium were subsequently slowly added dropwise with increased cooling. The mixture was stirred at 0° C., and the progress of the reaction was monitored by gas chromatography. When the reaction was complete, the cloudy solution was filtered, and the filtrate was distilled.

Yield: 9.2 g of 1,1,2,2,-tetrafluoroethyl-2-phenoxytrimethylsilane (43% of theory).

Boiling point: 91 to 92.5° C. at 10 mbar.

Mass spectrometry (m/e): (M^{+.})266, (M^{+.}−115) 151, (M^{+.}−189)77, (M^{+.} −215)51

¹⁹F-NMR data δ: −86 ppm (s, 2F, CF₂); −131 ppm (s, 2F, CF₂)

### Example 2

300 ml of methyl tert-butyl ether and 12.5 g (150 mmol) of triethyl-chlorosilane were introduced under nitrogen into a 1 liter four-necked flask fitted with stirrer, thermometer, and gas inlet capillary, and the mixture was cooled to 0° C. When the target temperature had been reached,10 g (83.4 mmol) of pentafluoroethane were added dropwise. 62.5 ml (125 mmol) of n-butyllithium were subsequently slowly added dropwise with increased cooling. The mixture was stirred at 0° C., and the progress of the reaction was monitored by gas chromatography. When the reaction was complete, the cloudy solution was filtered, and the filtrate was distilled.

Yield: 10.5 g of triethylpentafluoroethylsilane (54% of theory).

Boiling point: 50° C. at 30 mbar

### Example 3

450 ml of methyl tert-butyl ether and 27 g (180 mmol) of triethyl-chlorosilane were introduced under nitrogen into a 1 liter four-necked flask fitted with stirrer, thermometer, and gas inlet capillary, and the mixture was cooled to 0° C. When the target temperature had been reached, 23.8 g (180 mmol) of methoxytetrafluoroethane were added dropwise. 135 ml (270 mmol) of n-butyllithium were subsequently slowly added dropwise with increased cooling. The mixture was stirred at 0° C., and the progress of the reaction was monitored by gas chromatography. When the reaction was complete, the cloudy solution was filtered, the filtrate was distilled, and 1,1,2,2-tetrafluoroethyl-2-methoxytriethylsilane is obtained as a 10% solution in butyltriethylsilane.

Boiling point: 32° C. at 64 mbar

Mass spectrometry (m/e): (M^{+.}−29)217, (M^{+.}−129) 127, (M^{+.}−153)77, (M^{+.}−187)59, (M^{+.}−217)29

¹⁹F-NMR data δ: −93 ppm (s, 2F, CF₂); −126 ppm (s, 2F, CF₂)

What is claimed is:

1. A process for the preparation of polyfluoroalkylsilanes of formula (I) 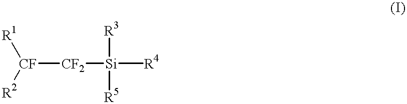
in which
R¹ and R² are identical or different and are hydrogen, halogen, straight-chain or branched C₁-C₈-alkyl, C₃-C₉-cycloalkyl, C₁-C₈-alkoxy, C₁-C₈-alkylthio, C₆-C₁₄-aryl, C₁-C₈-alkyl-, acyl-, sulfonyl-, or C₆-C₁₄-aryl-disubstituted amine, C₆-C₁₄-aryloxy, C₆-C₁₄-arylthio, heteroaryl, heteroaryloxy, or cyano, wherein said radicals, apart from hydrogen, halogen, and cyano, optionally carry one or more substituents selected from the series consisting of halogen, C₁-C₄-alkyl, C₁-C₄-alkoxy, C₆-C₁₄-aryloxy, silyloxy, nitro, cyano, C₁-C₄-alkyl-, acyl-, sulfonyl-, or C₆-C₁₄-aryl-disubstituted amine, disilylamino, and COO(C₁-C₆-alkyl), and
R³, R⁴, and R⁵ are identical or different and are straight-chain or branched C₁-C₈-alkyl or C₆-C₁₄-aryl, which optionally carry one or more substituents selected from the series consisting of halogen, C₁-C₄-alkyl, C₁-C₄-alkoxy, C₆-C₁₄-aryloxy, silyloxy, nitro, cyano, C₁-C₄-alkyl-, acyl-, sulfonyl-, or C₆-C₁₄-aryl-disubstituted amine, disilylamino, and COO(C₁-C₆-alkyl),
comprising reacting compounds of formula (II) 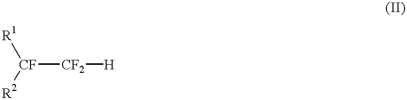
wherein R¹ and R² are as defined above,
with compounds of formula (III) 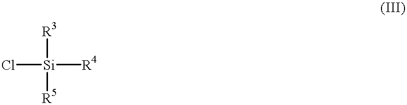
wherein R³, R⁴, and R⁵ are as defined above,
in the presence of a base.

2. A process according to claim 1 in which, in compounds of formula (II),
R¹ is hydrogen, halogen, straight-chain or branched C₁-C₈-alkyl, C₃-C₉-cycloalkyl, C₁-C₈-alkoxy, C₁-C₈-alkylthio, C₆-C₁₄-aryl, C₁-C₈-alkyl-, acyl-, sulfonyl-, or C₆-C₁₄-aryl-disubstituted amine, C₆-C₁₄-aryloxy, C₆-C₁₄-arylthio, heteroaryl, heteroaryloxy, or cyano, wherein said radicals, apart from hydrogen, halogen, and cyano, optionally carry one or more substituents selected from the series consisting of halogen, C₁-C₄-alkyl, C₁-C₄-alkoxy, C₆-C₁₄-aryloxy, silyloxy, nitro, cyano, C₁-C₄-alkyl-, acyl-, sulfonyl-, or C₆-C₁₄-aryl-disubstituted amine, disilylamino, and COO(C₁-C₆-alkyl), and
R² is halogen.

3. A process according to claim 1 in which, in compounds of formula (III),
R³, R⁴, and R⁵ are identical or different and are straight-chain or branched C₁-C₆-alkyl, which optionally carries one or more substituents selected from the series consisting of halogen, C₁-C₄-alkyl, C₁-C₄-alkoxy, C₆-C₁₄-aryloxy, silyloxy, nitro, cyano, C₁-C₄-alkyl-, acyl-, sulfonyl-, or C₆-C₁₄-aryl-disubstituted amine, disilylamino, and COO(C₁-C₆-alkyl).

4. A process according to claim 1 wherein the base is a strong base.

5. A process according to claim 1 wherein the amount of the base is from 0.5 to 20 equivalents, based on the compounds of the formula (II).

6. A compound of formula (I) 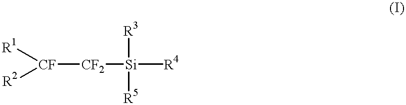
in which
R¹ and R² are identical or different and are hydrogen, halogen, straight-chain or branched C₁-C₈-alkyl, C₃-C₉-cycloalkyl, C₁-C₈-alkoxy, C₁-C₈-alkylthio, C₆-C₁₄-aryl, C₁-C₈-alkyl-, acyl-, sulfonyl-, or C₆-C₁₄-aryl-disubstituted amine, C₆-C₁₄-aryloxy, C₆-C₁₄-arylthio, heteroaryl, heteroaryloxy, or cyano, wherein said radicals, apart from hydrogen, halogen, and cyano, optionally carry one or more substituents selected from the series consisting of halogen, C₁-C₄-alkyl, C₁-C₄-alkoxy, C₆-C₁₄-aryloxy, silyloxy, nitro, cyano, C₁-C₄-alkyl-, acyl-, sulfonyl-, or C₆-C₁₄-aryl-disubstituted amine, disilylamino, and COO(C₁-C₆-alkyl), and
R³, R⁴, and R⁵ are identical or different and are straight-chain or branched C₁-C₈-alkyl or C₆-C₁₄-aryl, which optionally carry one or more substituents selected from the series consisting of halogen, C₁-C₄-alkyl, C₁-C₄-alkoxy, C₆-C₁₄-aryloxy, silyloxy, nitro, cyano, C₁-C₄-alkyl-, acyl-, sulfonyl-, or C₆-C₁₄-aryl-disubstituted amine, disilylamino, and COO(C₁-C₆-alkyl),
with the proviso that R¹ is not hydrogen, halogen, or fluoroalkyl if R² is fluorine or chlorine.

7. A compounds according to claim 6 in which R¹ is hydrogen, halogen, straight-chain or branched C₁-C₈-alkyl, C₃-C₉-cycloalkyl, C₁-C₈-alkoxy, C₁-C₈-alkylthio, C₆-C₁₄-aryl, C₁-C₈-alkyl-, acyl-, sulfonyl-, or C₆-C₁₄-aryl-disubstituted amine, C₆-C₁₄-aryloxy, C₆-C₁₄-arylthio, heteroaryl, heteroaryloxy, or cyano, wherein said radicals, apart from hydrogen, halogen, and cyano, optionally carry one or more substituents selected from the series consisting of halogen, C₁-C₄-alkyl, C₁-C₄-alkoxy, C₆-C₁₄-aryloxy, silyloxy, nitro, cyano, C₁-C₄-alkyl-, acyl-, sulfonyl-, or C₆-C₁₄-aryl-disubstituted amine, disilylamino, and COO(C₁-C₆-alkyl),
R² is halogen, and
R³, R⁴, and R⁵ are identical or different and are straight-chain or branched C₁-C₈-alkyl or C₆-C₁₄-aryl, which optionally carry one or more substituents selected from the series consisting of halogen, C₁-C₄-alkyl, C₁-C₄-alkoxy, C₆-C₁₄-aryloxy, silyloxy, nitro, cyano, C₁-C₄-alkyl-, acyl-, sulfonyl-, or C₆-C₁₄-aryl-disubstituted amine, disilylamino, and COO(C₁-C₆-alkyl),
with the proviso that R¹ is not hydrogen, halogen, or fluoroalkyl if R² is fluorine or chlorine.

8. A method comprising incorporating polyfluoroalkyl groups into a pharmaceutical or agrochemical active ingredient with a transfer agent, wherein the transfer agent is a polyfluoroalkylsilane prepared according to claim 1.

9. A method comprising incorporating polyfluoroalkyl groups into a liquid crystal with a transfer agent, wherein the transfer agent is a polyfluoroalkylsilane prepared according to claim 1.

10. A liquid crystal of formula (IV) 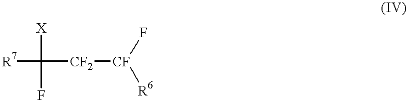
in which
X is fluorine or hydrogen,
R⁶ is hydrogen, fluorine, polyfluoro-C₁-C₈-alkyl, C₁-C₈-alkoxy, C₆-C₁₄-aryloxy, or heteroaryloxy, wherein said radicals, apart from hydrogen and fluorine, optionally carry one or more substituents selected from the series consisting of halogen, C₁-C₄-alkyl, C₁-C₄-alkoxy, C₆-C₁₄-aryloxy, silyloxy, nitro, cyano, C₁-C₄-alkyl-, acyl-, sulfonyl-, or C₆-C₁₄-aryl-disubstituted amine, disilylamino and COO(C₁-C₆-alkyl), and
R⁷ is optionally substituted C₆-C₁₄-aryl or C₆-C₁₈-cycloalkyl.

11. A liquid crystal according to claim 10 in which
X is hydrogen,
R⁶ is hydrogen, fluorine, polyfluoro-C₁-C₄-alkyl, or straight-chain or branched C₁-C₄-alkoxy, which, apart from hydrogen, fluorine, and polyfluoroalkyl, are substituted by one or more fluorine atoms, and
R⁷ is a phenyl radical, a biphenyl radical, or a cyclohexyl radical, which optionally carry one or more substituents selected from the series consisting of straight-chain or branched C₄-C₁₈-alkyl, C₁-C₁₂-alkyl-C₅-C₈-cycloalkyl, and C₅-C₈-cycloalkyl.

12. A process for the preparation of liquid crystals according to claim 10 comprising
process for the preparation of liquid crystals of formula (IV) comprising
(1) reacting compounds of formula (I) 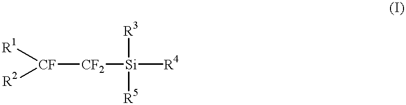
in which
R¹ is hydrogen, fluorine, polyfluoro-C₁-C₄-alkyl, or straight-chain or branched C₁-C₄-alkoxy, which, apart from hydrogen, fluorine, and polyfluoroalkyl, are substituted by one or more fluorine atoms.
R² is fluorine, and
R³, R⁴, and R⁵ are identical or different and are straight-chain or branched C₁-C₈-alkyl or C₆-C₁₄-aryl, which optionally carry one or more substituents selected from the series consisting of halogen, C₁-C₄-alkyl, C₁-C₄-alkoxy, C₆-C₁₄-aryloxy, silyloxy, nitro, cyano, C₁-C₄-alkyl-, acyl-, sulfonyl-, or C₆-C₁₄-aryl-disubstituted amine, disilylamino, and COO(C₁-C₆-alkyl),
with compounds of formula (V)
R⁷—Y (V)
in which
Y is a group that is reactive toward —SiR³R⁴R⁵ (preferably an aldehyde, keto, or ester group), and
R⁷ is optionally substituted C₆-C₁₄-aryl or C₆-C₁₈-cycloalkyl,
in the presence of compounds that have strong affinity to silicon, giving compounds of formula (VI) 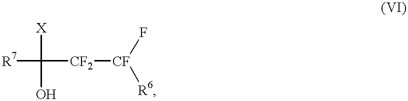
in which
R⁶ is hydrogen, fluorine, polyfluoro-C₁-C₄-alkyl, or straight-chain or branched C₁-C₄-alkoxy, which, apart from hydrogen, fluorine, and polyfluoroalkyl, are substituted by one or more fluorine atoms,
R⁷ is optionally substituted C₆-C₁₄-aryl or C₆-C₁₈-cycloalkyl, and
(2) subsequently reacting these compounds with a fluorinating agent.

13. An optical display containing a liquid crystal according to claim 10.
